(19) United States
(12) Patent Application Publication
(10) Pub. No.: US 2026/0086846 A1
(43) Pub. Date: Mar. 26, 2026

(54) OFFLOADING OPERATIONS USING A NETWORK INTERFACE CONTROLLER

(71) Applicants: Advanced Micro Devices, Inc., Santa Clara, CA (US); Xilinx, Inc., San Jose, CA (US)

(72) Inventors: Kenneth O'Brien, Dublin (IE); Lucian Petrica, Dublin (IE); Madhusudhanan Srinivasan, Austin, TX (US); Mark Richard Nutter, Austin, TX (US)

(73) Assignees: Advanced Micro Devices, Inc., Santa Clara, CA (US); Xilinx, Inc., San Jose, CA (US)

(21) Appl. No.: 18/898,370

(22) Filed: Sep. 26, 2024

(51) Int. Cl. G06F 9/48

(52) U.S. Cl. CPC G06F 9/4843

(57) ABSTRACT

Offloading operations for a computing system includes executing an application by a Central Processing Unit (CPU) of the computing system. The application includes a first set of operations and a second set of operations. The first set of operations may be executed by a Graphics Processing Unit of the computing system. The Graphics Processing Unit may execute the first set of operations under the control of the CPU. The second set of operations may be executed by a Smart Network Interface Controller of the computing system. The Smart Network Interface Controller may execute the second set of operations under control of the CPU.

### TECHNICAL FIELD

This disclosure relates to cloud computing and, more particularly, to offloading certain operations of an application to one or more Smart Network Interface Controllers (SNICs) and/or one or more client devices.

### BACKGROUND

Many computing environments involve a cloud computing system in communication with one or more client devices. The cloud computing system may include one or more cloud computing nodes. A cloud computing node may be embodied as a server (e.g., a physical server). A cloud computing node may execute one or more virtual machines. Often, the cloud computing system includes a sufficient number of cloud computing nodes so as to be able to communicate with many client devices. An example of a cloud computing system may include a gaming platform.

The cloud computing node includes one or more Central Processing Units (CPUs), also referred to as host processors, and one or more Graphics Processing Units (GPUs). In a typical arrangement, the CPU of a cloud computing node is capable of executing an application such as an online game. In executing the application, the host processor is capable of offloading certain operations of the application to the GPU for execution.

### SUMMARY

In one or more embodiments, a computer-implemented method includes executing an application by a Central Processing Unit (CPU) of a computing system. The application includes a first set of operations and a second set of operations. The computer-implemented method includes executing, under control of the CPU, the first set of operations by a Graphics Processing Unit (GPU) of the computing system. The computer-implemented method includes executing, under control of the CPU, the second set of operations by a Smart Network Interface Controller (SNIC) of the computing system.

In one or more embodiments, a system includes a CPU capable of executing an application. The application includes a first set of operations and a second set of operations. The system includes a GPU capable of executing, under control of the CPU, the first set of operations. The system includes an SNIC capable of executing, under control of the CPU, the second set of operations.

In one or more embodiments, a computer program product includes a computer readable storage medium having program instructions embodied therewith. The program instructions are executable by computer hardware, e.g., a hardware processor such as a CPU, GPU, and/or SNIC, to cause the computer hardware to execute operations as described within this disclosure.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments of the disclosed technology. The drawings, however, should not be construed to be limiting of the inventive arrangements to only the embodiments shown. Various aspects and advantages will become apparent upon review of the following detailed description and upon reference to the drawings.

FIG. 1 illustrates an example computing environment in accordance with one or more embodiments of the disclosed technology.

FIG. 2 illustrates vertical distribution of operations where offloading occurs between a Smart Network Interface Controller (SNIC) and a client device in accordance with one or more embodiments of the disclosed technology.

FIG. 3 illustrates horizontal distribution of operations where offloading occurs between a plurality of SNICs in accordance with one or more embodiments of the disclosed technology.

FIG. 4 illustrates another example of horizontal distribution of operations in accordance with one or more embodiments of the disclosed technology.

FIG. 5 illustrates a method of offloading operations using an SNIC in accordance with one or more embodiments of the disclosed technology.

FIG. 6 illustrates a method of offloading operations using an SNIC in accordance with one or more embodiments of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to cloud computing and, more particularly, to offloading certain operations of an application to one or more Smart Network Interface Controllers (SNICs) and/or one or more client devices. In accordance with the inventive arrangements described within this disclosure, methods, systems, and computer program products are disclosed in which certain operations of an application may be offloaded from a Central Processing Unit (CPU) of a computer system to a Graphics Processing Unit (GPU) of the computer system. Certain other operations of the application may be offloaded from the CPU to one or more SNICs. In one or more embodiments, certain operations also may be offloaded from the one or more SNICs to the client device.

Certain classes of applications may include a first set of operations and a second set of operations. The first set of operations are capable of executing more efficiently when data structures are colocated while the second set of operations does not benefit from colocation of data structures. For example, colocation of data structures may allow the first set of operations to execute more efficiently as measured by faster or reduced runtime while colocation of data structures for the second set of operations does not result in any increase in such efficiency. The CPU, in executing the application, is capable of implementing a split processing model in which the first set of operations are offloaded to the GPU for execution and the second set of operations are offloaded to one or more SNICs for execution.

In general, “colocated operations” refer to executable operations or tasks that operate on, access, and/or share one or more same data structures. Colocation refers to the notion that greater computational efficiency (e.g., reduced runtime) may be achieved in cases where colocated operations are executed using a same processing element or device. In one or more examples, the device may be a GPU of a data processing system. The computational efficiency arises, at least in part, from the reduction in the number of data transfers needed to support execution of the colocated operations since the various colocated operations utilize many of the same data structures that may remain resident in runtime memory of the particular device.

“Non-colocated operations” refer to executable operations or tasks that do not operate on, access, or share the same data structures. Non-colocated operations may be offloaded to a processing element such as a SNIC without incurring a computational performance penalty for doing so, e.g., without a slowing or increasing runtime. The ability to offload non-colocated operations without incurring a computational penalty arises, at least in part, because the number of data transfers needed to perform the non-colocated operations, whether performed by one particular device such as the GPU or another such as the SNIC remains substantially unchanged.

In one or more embodiments, selected operations that have been offloaded to the SNIC, e.g., non-colocated operations, may be further offloaded to one or more other SNICs for execution using a horizontal distribution model. In one or more other embodiments, selected operations that have been offloaded to the SNIC may be offloaded to the client device for execution using a vertical distribution model. In still other embodiments, selected operations that have been offloaded to the SNIC, e.g., non-colocated operations, may be offloaded to one or more other SNICs for execution using the horizontal distribution model and/or offloaded to the client device using the vertical distribution model. The offloading of operations as described herein may be performed in real-time in a dynamic manner that is responsive to offloading metrics detected or measured within the cloud computing system and/or the client device.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

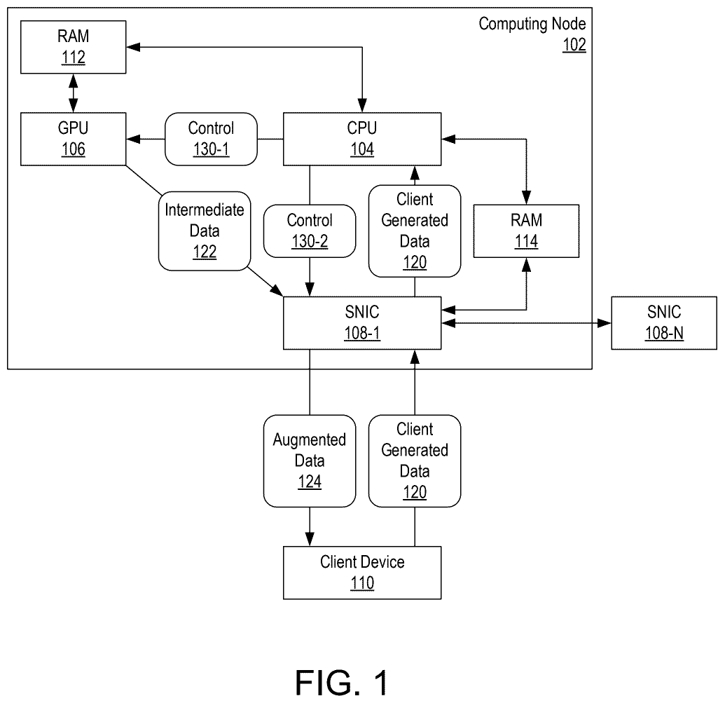

FIG. 1 illustrates an example computing environment 100 in accordance with one or more embodiments of the disclosed technology. Computing environment 100 includes a computing node 102 and one or more client devices such as client device 110. Computing node 102 may be part of a larger cloud computing system that includes one or more additional computing nodes (not shown) coupled to computing node 102. Computing node 102 may be implemented as a server, a cloud computing node, a data processing system, or another type of computer system.

In the example, computing node 102 includes a CPU 104, a GPU 106, and an SNIC 108 (i.e., SNIC 108-1). Each of CPU 104, GPU 106, and SNIC 108-1 may be implemented as a hardware processor that is embodied as one or more circuits. With respect to CPU 104 and GPU 106, such circuits may be capable of executing computer-readable program instructions (program instructions). GPU 106 may also include dedicated graphics processing circuit blocks.

A NIC typically functions as an interface between a cloud computing node and one or more client devices in communication with that cloud computing node. A Smart NIC or SNIC is a NIC that is capable of performing one or more processing functions. That is, a smart NIC will include some computational capability beyond the conventional processing capabilities of a NIC. SNICs 108 may include one or more dedicated circuit blocks. SNICs 108 also may include circuits capable of executing program code.

In one or more embodiments, computing environment 100 includes more than one SNIC illustrated in FIG. 1 as SNIC 108-1 through SNIC 108-N, where N is an integer value of 2 or more. In the example of FIG. 1, each additional SNIC 108 may be part of, or included in, a different computing node. For example, SNIC 108-1 is included in computing node 102 while SNIC 108-N is included in a different computing node (not shown in FIG. 1). SNIC 108-1 and SNIC 108-N are coupled so as to be capable of communicating. The connection between SNIC 108-1 and SNIC 108-N may be indirect (with one or more intervening elements between SNICs 108-1 and 108-N) or direct (e.g., without any intervening elements between SNICs 108-1 and 108-N). In one or more other embodiments, a given computing node, e.g., computing node 102, may include a plurality of SNICs 108. In that case, SNIC 108-1 through 108-N may be included in computing node 102. In general, SNICs may be paired or colocated with a corresponding CPU.

The particular architecture of CPU 104, GPU 106, and/or SNIC 108 is not intended as a limitation of the inventive arrangements described within this disclosure.

Computing node 102 may include a random-access memory (RAM) 112 that may be accessed by CPU 104 and/or GPU 106. Computing node 102 also may include a RAM 114 that may be accessed by CPU 104 and/or SNIC 108. With reference to FIG. 1, RAM 112 and RAM 114 are examples of runtime memory.

Computing node 102 may be part of a cloud computing system. The cloud computing system is capable of serving one or more client devices such as client device 110. Though one client device is illustrated in the example of FIG. 1, it should be appreciated that computing node 102 may be in communication with, or serve, many client devices (e.g., tens, hundreds, or possibly thousands).

Client device 110 may be any of a variety of computing devices including, but not limited to, a personal computer, a tablet computer, a mobile computing device (e.g., a mobile smart phone), a gaming console, an Internet-of-Things (IoT) enabled device, a smart appliance, a wearable computing device such as smart glasses, a virtual reality headset, ear phones and/or buds, an augmented reality headset, or the like.

In one or more embodiments, operations of an application (e.g., program instructions) executed by computing node 102 may be split across different computing elements of computing node 102, across different computing elements of multiple computing nodes, and/or across computing node 102 (or multiple computing nodes) and client device 110. In general, colocated operations of the application may be offloaded from CPU 104 to GPU 106 under control of CPU 104. Non-colocated operations of the application may be offloaded from CPU 104 to SNIC 108-1 under control of CPU 104. In one or more embodiments, selected non-colocated operations offloaded to SNIC 108-1 may be further offloaded to one or more other SNICs 108 and/or to client device 110.

In general, the decision to offload a non-colocated operation to SNIC 108-1, to one or more other SNICs 108, and/or to client device 110 may be made in real-time, e.g., dynamically, based on offloading metrics. The offloading metrics specify information that, when compared with predetermined offloading criteria, whether for client devices or for other SNICs, indicate whether to offload certain operations. The offloading metrics may include, but are not limited to, latency of client device 110 in performing operations, cloud resource allocation efficiency, image quality as displayed in client device 110, client power and/or energy efficiency (e.g., in the case where client device 110 is a mobile device), power dissipation of the cloud system (e.g., computing node 102), power consumption of the cloud system (e.g., computing node 102), workload of the computing node 102 whether GPU 106 or SNIC 108, workload of client device 110, and/or whether a given set of two or more users/players share a context or state of the application such that data may be shared as described below in greater detail. Thus, whether a given non-colocated operation is offloaded to SNIC 108-1, one or more other SNICs 108, and/or to client device 110 may depend on measurement of these different offloading metrics in comparison with offloading criteria.

For purposes of illustration, consider an example in which computing node 102 is part of a cloud computing system executing an online gaming application and is configured to serve client device 110. In general, computing node 102 is capable of performing operations such as keeping a state of the online gaming application as updated by the game logic of the application and based on user input, rendering graphical output of the game, and streaming the graphical output to client device 110 over a network (e.g., whether wired and/or wireless) not shown. Client device 110 is capable of sending user inputs to computing node 102, receiving the stream of video data (e.g., images) from computing node 102, and displaying the video data to a user. Within this disclosure, the term “image” and “frame” are used interchangeably in that a video or video stream may be formed of a sequence of images often referred to as frames, frames of video, or video frames.

As gaming is an interactive activity, the importance of minimizing latency between the user's inputs and the resulting graphical output generated by computing node 102 is significant. If latency is too high, the user's experience in playing the game is degraded. Too much latency may render an application unusable (e.g., render a game unplayable). Generation of graphical output such as a video stream typically entails the execution of a graphics rendering pipeline in addition to the execution of one or more neural post-processing (NPP) operations that enhance the graphical output.

Graphics rendering pipeline operations may include, but are not limited to, operations that convert a 3-dimensional image or scene into a 2-dimensional image for display on a display device. Graphics rendering pipeline operations may include, but are not limited to, vertex processing that converts each vertex into a 2-dimensional screen position, clipping that removes parts of an image that are not visible on the screen, primitive assembly that collects vertices and converts vertices into triangles, rasterization that fills triangles with pixels, applying lighting to a scene or image, applying shading to a scene or image, projection transformation that applies a projection transformation to a scene or image, texturing that applies texture to a scene or image, and/or depth test that detects whether a pixel has already been computed for a closer object.

The NPP operations implement further transformations of the stream of images generated by GPU 106 in executing the graphics rendering pipeline. The NPP operations may include operations such as upscaling, denoising, frame interpolation, and frame extrapolation. In modern computing systems, these operations are often implemented using one or more machine learning models.

In conventional computing environments, the NPP operations are executed on the same GPU as the graphics rendering pipeline. This means that each client device may spawn two tightly coupled and, therefore, co-located, processes within the cloud system. The first process is a GPU process that is responsible for executing the graphics rendering pipeline. The second process is also a GPU process that is tightly coupled to the first process. The second process is responsible for executing the NPP operations on data generated by the first process.

In some cases, multiple client devices may be served by the same GPU. In this scenario, the graphics rendering pipelines for the respective client devices may be colocated on the same GPU so that graphics-specific data structures of the rendering pipelines may be shared. Such may be the case, for example, in cases where the client devices share views, textures, and/or the like. An illustrative example of such a situation is where two users are in a same room (e.g., a same virtual room) of a first-person action game. Graphics data structures can be shared across multiple render passes and/or the like. The graphics rendering pipeline as executed by GPU 106 benefits from a shared context for these data structures.

Co-location of the respective NPP operations on the same GPU does not provide the same benefits as co-location of the graphics rendering pipeline because many NPP operations are applied or performed at the pixel level. Co-location of NPP operations on the CPU with the graphics rendering pipeline prevents the co-location of a larger number of client devices on the same GPU. That is, the GPU is prevented from handling an even larger number of graphics rendering operations, to which the GPU is suited, for an even larger number of client devices (e.g., users).

Considering the example above and referring to FIG. 1, CPU 104 may execute game logic, process user input, and maintain a state of play of the user's session with computing environment 100. GPU 106 is capable of executing a first set of operations that may include a graphics rendering pipeline and optionally one or more NPP operations. SNIC 108 is capable of executing a second set of operations such as NPP operations, encoding a video stream, providing the encoded video stream to client device 110, optionally compressing the video stream prior to providing the video stream to client device 110, and collecting per-client telemetry data. The telemetry data collected may be used by SNIC 108 in making decisions as to how to load balance the NPP operations (e.g., Artificial Intelligence and/or machine learning workloads) in terms of which operations may be offloaded and to which entity.

Accordingly, CPU 104 is capable of splitting the work of the graphics rendering pipeline and the NPP operations between GPU 106 and SNIC 108. This allows for operations of the graphics rendering pipeline that benefit from shared context such as graphics rendering, rasterization, and ray tracing, to be decoupled from the operations that do not benefit from shared context such as NPP operations. As noted, CPU 104 may offload the graphics rendering pipeline operations to the GPU and offload other operations to the SNIC 108.

In the example of FIG. 1, NPP operations can be executed on SNIC(s) 108, GPU 106, and/or client device 110. The particular processing device on which any given NPP operation is executed may be dictated by a system configuration for computing environment 100. In one or more embodiments, the system configuration that dictates which processing device will execute the NPP operations may specify offloading criteria that may be compared with the offloading metrics. The offloading criteria may include SNIC offloading criteria and/or client offloading criteria.

In general, SNIC 108-1 is capable of comparing the offloading metrics, as may be determined or collected in real-time or in near real-time, with the offloading criteria. In some embodiments, the offloading criteria may specify a prioritization of the offloading metrics such that one or more offloading metrics are given greater weight or higher priority when considering whether to offload a given operation or set of operations to another SNIC or client device. Accordingly, decisions to offload non-colocated tasks such as NPP operations to GPU 106, to SNIC(s) 108, and/or to client device 110 may be made in real-time, e.g., dynamically, based on a current operating state of computing environment 100 and/or client device 110 as reflected in the offloading metrics compared to the offloading criteria.

In some cases, particular operations may be classified as, or considered, colocated in some contexts and be classified as non-colocated in other contexts. The classification of operations may change dynamically during execution of the application. This classification may dictate whether a given operation may be offloaded to the SNIC.

For example, in a multiplayer game, players A and B may be located in a same virtual environment such as a same virtual room, e.g., a first virtual room. As such, certain data structures for both players A and B may be common making operations that utilize such data structures colocated operations. If player B moves to a different virtual environment, e.g., a second virtual room while player A remains in the first virtual room, players A and B may no longer share same data structures. In consequence, responsive to changing state of the game or application, e.g., player B moving, operations such as the graphics rendering pipeline for both player A and player B that were previously colocated may be reclassified as non-colocated operations. This makes the set of operations that may be offloaded to SNIC(s) 108 and/or to client device 110 subject to change in real-time during execution of the application based on state of the application and/or users of the application (e.g., players).

While the example of online gaming is used throughout this disclosure, it should be appreciated that the inventive arrangements may be used for other applications, use cases, and/or contexts. As an illustrative and non-limiting example, the inventive arrangements may be used generally for cloud-based video processing, cloud-based graphics generation, cloud-based graphics processing, and/or graphics and/or video delivery.

In another example, the inventive arrangements may be used for simulation applications or applications that utilize digital twins. Simulation related operations may be considered colocated operations while other operations such as interface querying operations may be considered non-colocated operations. For example, the application may be a science application such as one capable of weather simulation that includes mesh simulation operations that benefit from colocation and one or more neural-network-based operations that execute on simulation results that do not benefit from colocation. In another example, the inventive arrangements may be used with a neural rendering application. An example of a neural rendering application may include a machine learning application or function that is capable of increasing resolution of images while keeping the images sharp and detailed.

In general, the inventive arrangements may be used in executing any type of application that includes one or more operations that benefit from colocation and one or more operations that do not benefit from colocation (e.g., non-colocated operations).

Referring again to FIG. 1, computing environment 100 illustrates several different processing loops each with a differing amount of latency. For example, computing environment 100 implements a “full latency loop” that represents operations such as receiving and processing user input or other data originating from client device 110 shown as client generated data 120, updating state of the application by CPU 104 based on client generated data 120, GPU 106 performing one or more colocated operations such as partially rendering one or more frames, forwarding the partially rendered frames illustrated as intermediate data 122 to SNIC 108-1, SNIC 108-1 executing one or more non-colocated operations such as one or more NPP operations on and/or using intermediate data 122 to generate augmented data 124, and providing augmented data 124 to client device 110.

As noted, the NPP operations may include operations such as encoding video data, e.g., a video stream, to be provided to client device 110. Example operations that may be performed within the full latency loop may include loading a new game level or interacting with other users in a multi-player game.

In one or more embodiments, augmented data 124 may be final data in that augmented data 124 requires no further processing by client device 110. For example, augmented data 124 may include frame(s) that need only be displayed by client device 110 upon receipt. In one or more other embodiments, augmented data 124 is data that requires further processing by client device 110 prior to display or other usage of that data by client device 110. For example, augmented data 124 may include frame(s) that require upscaling or interpolation by client device 110 prior to display. Whether augmented data 124 is final data or data that requires further processing by client device 110 may vary dynamically, e.g., in real-time, based on which non-colocation operations are offloaded to SNIC 108-1 and/or other SNICs 108 and which, if any, non-colocation operations are offloaded from SNIC 108-1 to client device 110.

As illustrated in FIG. 1, CPU 104 may provide control data and/or signals shown as control data 130-1 and control data 130-2 to GPU 106 and to SNIC 108-1, respectively. CPU 104 offloads certain operations to GPU 106 by way of control data 130-1 and offloads certain other operations to SNIC 108-1 by way of control data 130-2.

Computing environment 100 also illustrates a “lower latency loop” that represents functions or operations relating to interactions between client device 110 and computing node 102 that occur through SNIC 108-1. The lower latency loop may encompass operations including, but not limited to, client device 110 receiving a frame from SNIC 108, client device 110 displaying a frame, client device 110 capturing user input(s), and/or client device 110 sending the user inputs to SNIC 108-1 as client generated data 120. In one or more embodiments, the lower latency loop may include client device 110 executing one or more non-colocated operations offloaded from SNIC 108-1. Examples of operations that may be implemented as part of the lower latency loop may include, but are not limited to, adaptive framerate (e.g., adjusting the framerate), adaptive resolution (e.g., adjusting the resolution of frames), applying High Dynamic Range (HDR) effects, and adjusting lighting or other attributes of frames.

Computing environment 100 also illustrates a “lowest latency loop” that represents functions or operations executed on client device 110. While the lowest latency loop does provide the lowest latency as its name suggests, this latency comes at the cost of consuming additional compute (e.g., computational resources) of client device 110. The lowest latency is achieved in that there is no direct dependency of operations or interactions between client device 110 and computing node 102 for a period of time. In performing operations considered within the lowest latency loop, client device 110 is capable of synchronizing with computing node 102 to keep or maintain a sane state of the application (e.g., the online game). This synchronization, however, occurs less often or less frequently than with the lower latency loop.

For example, in the lowest latency loop, the client device 110 may perform some light rendering that may be somewhat speculative in that confirmation from computing node 102 that the modifications (e.g., rendering by client device 110) are congruent with the application state of CPU 104 is not obtained for a period of time. Because client device 110 is “far” from the application state maintained by CPU 104, realignment between that state and the client-based rendering may take several frames. During this time, operation (e.g., gameplay) on client device 110 is well aligned with user input such as keyboard input because of the local rendering performed by client device 110. As noted, the lower latency loop would synchronize client device 110 more often with the state maintained by CPU 104 but may be less responsive to user input due to the user input traversing to computing node 102 and video having to traverse from computing node 102 to client device 110.

In implementing operations as part of the lowest latency loop and enabling such operation by client device 110, GPU 106 may partially render frame(s). Further, NPP operations may be performed on GPU 106 and/or SNIC 108-1. Example operations performed by client device 110 as part of the lowest latency loop may include, but are not limited to, image warping with camera movement, super resolution, and/or image-based lighting adjustment.

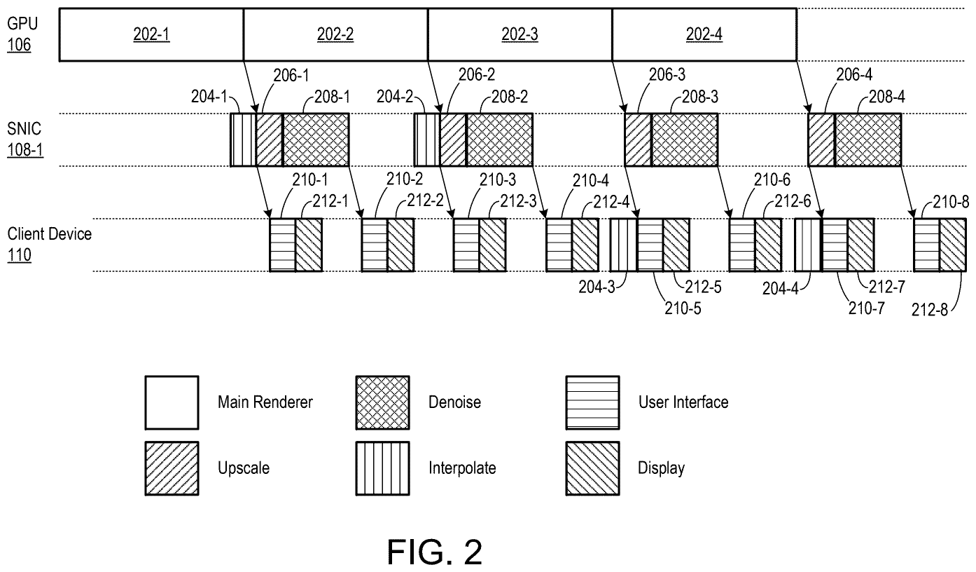

FIG. 2 illustrates offloading as performed by computing environment 100 of FIG. 1 in accordance with one or more embodiments of the disclosed technology. FIG. 2 is an example of vertical distribution of operations in that the offloading occurs between SNIC 108-1 and client device 110. In the example, a variety of different operations are illustrated which include main renderer, upscale, denoise, interpolate, user interface, and display. In the example, these operations are offloaded by CPU 104 and split out among GPU 106 and SNIC 108-1. SNIC 108-1 is capable of interacting with client device 110 to further offload operations to client device 110. The offloading between SNIC 108-1 and client device 110 may be performed dynamically.

Within conventional computing nodes, offloading is often restricted to offloading operations from the CPU to the GPU for execution. Some operations also may be offloaded to the client device for execution. In the case of modern graphics processing that utilizes NPP operations, the NPP operations would be offloaded to the client device thereby saving computational resources of the GPU by avoiding inefficient executing of such operations. These operations, however, are often too computationally intensive for execution on a client device. Often, a client device is unable to execute such operations as may be offloaded while also providing or maintaining reliable operation.

In the example of FIG. 2, operations may be offloaded to GPU 106 and/or to SNIC 108-1 by CPU 104. Further, SNIC 108-1 may offload selected operations to client device 110. As shown, CPU 104 offloads main rendering operations 202 (e.g., main rendering operations 202-1, 202-2, 202-3, and 202-4) to GPU 106. Operations such as interpolate 204 are, at least initially, offloaded by CPU 104 to SNIC 108-1. Operations such as upscale 206 and denoise 208 are offloaded to SNIC 108-1 for the entire window of time illustrated in FIG. 2. Operations such as user interface 210 and display 212 are performed by client device 110 for the entire window of time illustrated in FIG. 2. For the portions of time that SNIC 108-1 does not perform interpolate 204, the interpolate 204 operation is offloaded from SNIC 108-1 to client device 110.

For example, intermediate data generated by GPU 106 from executing main renderer 202-1 is provided to SNIC 108-1. SNIC 108-1 processes the intermediate data generated by main renderer 202-1 through interpolate 204-1, upscale 206-1, and denoise 208-1 to generate augmented data. The augmented data is then provided to client device 110, which processes the augmented data through user interface 210-1 and display 212-1 and also through user interface 210-2 and display 212-2. Here, the augmented data may be considered final data in that the augmented data does not require further processing by client device 110.

Continuing, intermediate data generated by GPU 106 from executing main renderer 202-2 is provided to SNIC 108-1. SNIC 108-1 processes the intermediate data generated by main renderer 202-2 through interpolate 204-2, upscale 206-2, and denoise 208-2 to generate augmented data. The augmented data is then provided to client device 110, which processes the augmented data through user interface 210-3 and display 212-3 and also through user interface 210-4 and display 212-4. Here too, the augmented data may be considered final data as the augmented data does not require further processing by client device 110.

Continuing, intermediate data generated by GPU 106 from executing main renderer 202-3 is provided to SNIC 108-1. SNIC 108-1 processes the intermediate data generated by main renderer 202-3 through upscale 206-3 and denoise 208-3 to generate augmented data. The augmented data is then provided to client device 110, which processes the augmented data through interpolate 204-3, user interface 210-5 and display 212-5 and also through user interface 210-6 and display 212-6. In this case, interpolate 204 (e.g., 204-3) is dynamically offloaded from SNIC 108-1 to client device 110. Here, the augmented data may be non-final data in that the augmented data does require further processing (e.g., interpolation) by client device 110 prior to display.

Continuing, intermediate data generated by GPU 106 from executing main renderer 202-4 is provided to SNIC 108-1. SNIC 108-1 processes the intermediate data generated by main renderer 202-4 through upscale 206-4 and denoise 208-4 to generate augmented data. The augmented data is then provided to client device 110, which processes the augmented data through interpolate 204-4, user interface 210-7 and display 212-7 and also through user interface 210-8 and display 212-8. In this case, interpolate 204 (e.g., 204-4) remains offloaded from SNIC 108-1 to client device 110. Here too, the augmented data may be considered non-final data in that the augmented data does require further processing (e.g., interpolation) by client device 110 prior to display.

The example of FIG. 2 illustrates the offloading of one or more NPP operations such as the interpolation operation from SNIC 108-1 to client device 110. For purposes of illustration, the offloading of one or more NPP operations such as the interpolation operation from SNIC 108-1 to client device 110 may coincide with a transition in client device 110 from a first operating mode such as a low power mode to a second and different operating mode in which client device 110 is permitted to perform additional computational tasks. As an example, client device 110 may initially operate on battery power and transition to the second operating mode when plugged into a power source. While in low power mode, for example, client device 110 may provide telemetry data to SNIC 108-1 specifying the low power mode as an offloading metric. In response SNIC 108-1 compares the offloading metric with client offloading criteria and decides not to offload the interpolate operation to client device 110. In this state, for example, SNIC 108-1 may execute all NPP operations and send encoded frames to client device 110 as final data such that client device 110 need only display the frames.

The second operating mode may be a high-performance mode or a low-bandwidth mode. In either operating mode, client device 110 is able to devote greater computational resources to offloaded operations. This also has the effect of reducing the amount of data sent from SNIC 108-1 to client device 110. For example, with client device 110 performing interpolation, the amount of data sent from SNIC 108-1 to client device 110 may be reduced by approximately one-half. Accordingly, in one or more embodiments, in response to implementing the second operation mode (e.g., changing from one operating mode to a different operating mode) client device 110 may provide telemetry data to SNIC 108-1 specifying the new (e.g., second) operating mode as an offloading metric.

In one or more other embodiments, SNIC 108-1 may detect that a predetermined bandwidth limit has been reached and, in response, delegate interpolation to client device 110 such that the bandwidth to client device 110 is reduced to approximately half of the prior bandwidth albeit at the cost of extra work being performed on client device 110. The dynamic allocation of operations such as NPP work may occur through direct negotiation between SNIC 108-1 and client device 110 and may minimize latency. Appreciably, a computationally more powerful client device may routinely take on offloaded operations (e.g., a gaming console).

Thus, the offloading may be performed by SNIC 108-1 where SNIC 108-1 initiates the offloading to client device 110 or where SNIC 108-1 reacts to changing conditions in client device 110. Within this disclosure, the term “offload” and “delegate” may be used interchangeably.

In the example of FIG. 2, empty space between operations, whether for GPU 106, SNIC 108-1, or client device 110, indicates that the particular device has additional computational capacity that is not being utilized. In the example, GPU 106 is fully utilized. Neither SNIC 108-1 nor client device 110 is fully utilized. The computational capacity of client device 110 is utilized to a greater degree as interpolation is offloaded from SNIC 108-1 thereto, while this offloading frees up computational capacity of SNIC 108-1.

As may be appreciated, whether particular operations may be offloaded to SNIC 108-1 and/or to client device 110 may change dynamically over time based on the operating mode and/or availability of computing resources of each respective device (e.g., in view of any other operations executing in the respective device over time). As computing node 102 serves client device 110, for example, client device 110 may provide real-time telemetry that may be used by SNIC 108-1 as offloading metrics in determining whether to offload operations thereto. It should be appreciated that internal operating conditions (e.g., state) of SNIC 108-1 also may be used as offloading metrics to decide whether to offload operations to client device 110 and/or to another SNIC 108.

Further examples of offloading metrics that may be used to determine whether to offload operations from SNIC 108-1 to client device 110 may relate to client device 110 itself, to server (e.g., computing node 102) state including application state and/or state of different users of the application, or a combination of both. With respect to client device 110, examples of metrics may include hardware capabilities of client device 110, image quality settings, refresh rate, desired latency, and/or bandwidth of communications between client device 110 and computing node 102. Client device 110 may communicate current telemetry data to computing node 102 including SNIC 108-1 indicating such quantities over time. With respect to computing node 102, example offloading metrics may include server/client ratio and/or cloud server load on one or more or any component that affects performance of execution of the application. The load on computing node 102, as measured by the noted offloading metrics herein, may be reduced by offloading operations to the client device.

The example of FIG. 2 illustrates operation with a single client device. It should be appreciated that the embodiments described herein may be scaled across a plurality, e.g., many client devices. In the example, GPU 106 is relieved of all NPP work allowing GPU 106 to co-locate render passes for maximum coherence and throughput. The NPP work is dynamically split between SNIC 108-1 and client device 110.

It should be appreciated that SNIC 108-1 may initially execute particular operations as delegated from the CPU (e.g., under control of the CPU). The delegation of operations from SNIC 108-1 to one or more other SNICs and/or from SNIC 108-1 to client device 110, however, may be performed under the sole discretion of SNIC 108-1 and/or by way of a negotiation between SNIC 108-1 and the respective devices to which offloading may occur. That is, the delegation from SNIC 108-1 to one or more other SNICs and/or client device 110 need not be performed under control of the CPU. In other words, the offloading from SNIC 108-1 to one or more other SNICs and/or to client device 110 may be performed by SNIC 108-1 without any involvement from the CPU. In this regard, SNIC 108-1 has agency to take certain latency critical actions with regard to delegation without involving the CPU in the long-latency loop. As an example, SNIC 108-1 may delegate to SNIC 108-N without CPU involvement in the low latency loop.

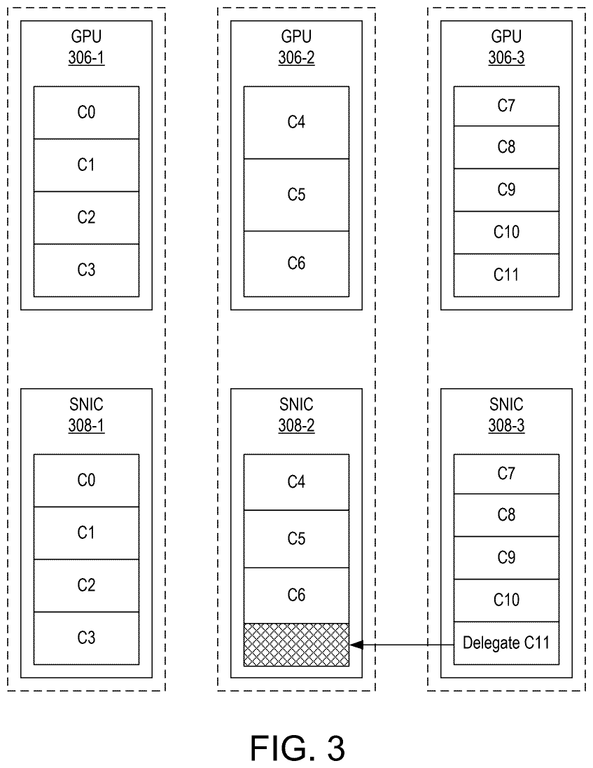

FIG. 3 illustrates allocation of GPU and SNIC resources in accordance with one or more embodiments of the disclosed technology. In the example of FIG. 3, three GPUs 306-1, 306-2, and 306-3 are illustrated. Each GPU 306 may be paired with a corresponding SNIC 308. For example, GPU 306-1 may be paired with SNIC 308-1, GPU 306-2 may be paired with SNIC 308-2, and GPU 306-3 may be paired with SNIC 308-3. In one or more embodiments, GPUs 306 and SNICs 308 may be included in a same computing node. In one or more other embodiments, GPUs 306 and SNICs 308 may be disposed in different computing node (e.g., GPU 306-1 and SNIC 308-1 in a first computing node, GPU 306-2 and SNIC 308-1 in a second computing node, and GPU 306-3 and SNIC 308-3 in a third computing node). The blocks C0 through C11 (e.g., C0, C1, C2, C3, C4, C5, C6, C7, C8, C9, C10, and C11) may represent operations corresponding to different client devices (e.g., different users) 1-11. Thus, 12 client devices are being served in this example.

In the example, each client device owns a GPU 306 process and an SNIC 308 process. At least initially, a client device process is allocated to a GPU 306 so long as performance requirements are met. Further, a 1:1 mapping may be achieved between GPU processes and processes on a corresponding SNIC 308. For example, GPU 306-1 executes processes for client devices C0, C1, C2, and C3. SNIC 308-1, which is paired with GPU 306-1, also executes processes for client devices C0, C1, C2, and C3. Similarly, GPU 306-2 executes processes for client devices C4, C5, and C6. SNIC 308-2, which is paired with GPU 306-2, also executes processes for client devices C4, C5, and C6. GPU 306-3 executes processes for client devices C7, C8, C9, C10, and C11. SNIC 308-3, which is paired with GPU 306-3, also executes processes for client devices C7, C8, C9, C10, and C11.

In the example of FIG. 3, GPU 306-2 has a heavier graphical workload in that GPU 306-2 is running fewer, e.g., three, GPU process than the other two GPUs. This may be a result, for example, of running an application or game with high resource demands. GPU 306-3 is running five lightweight client processes. In the example, GPUs 306 are efficiently utilized, e.g., balanced in terms of load. The resulting SNIC 308 utilization, however, is unbalanced in terms of load. The patterned block of SNIC 308-2 illustrates that SNIC 308-2 is underutilized (e.g., has computing capacity). SNIC 308-3 may be overutilized. In accordance with the inventive arrangements described within this disclosure, SNIC 308-3 is capable of requesting offload of the process for client device C11 to SNIC 308-2. SNIC 308-2, not being fully utilized, is capable of responding to request from SNIC 308-3 and accept the offload request. Accordingly, SNIC 308-3, which is overloaded with client devices, is capable of offloading the process for client device C11to SNIC 308-2 to utilize the spare or unused computational capacity therein.

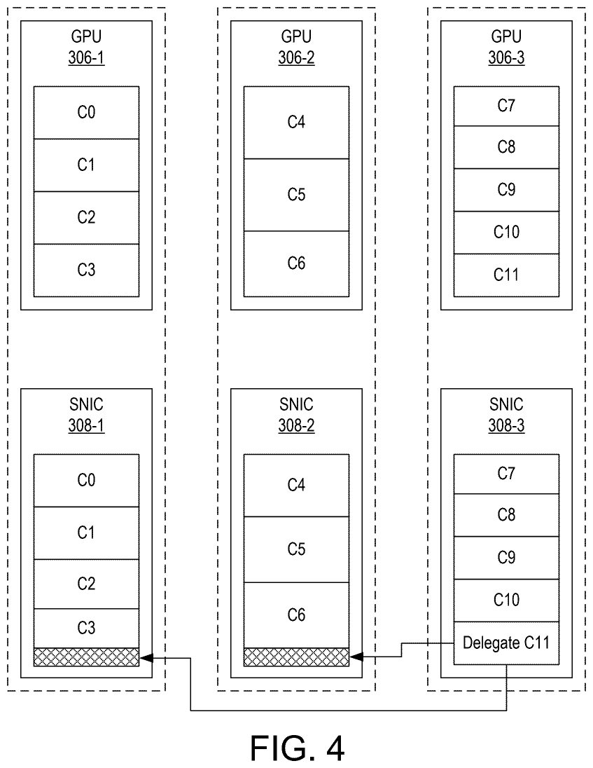

FIG. 4 illustrates allocation of GPU and SNIC resources in accordance with one or more embodiments of the disclosed technology. In the example of FIG. 4, no single SNIC 308 may have sufficient computing resources to be able to execute an entire process for a client device. Not one of GPU 306-1, 306-2, and GPU 306-3 has sufficient spare or unused computing resources to execute the entire process for client device C11. As an illustrative example, not one of GPU 306-1, 306-2, and GPU 306-3 has sufficient spare or unused computing capacity to execute an entire NPP pipeline for client device C11.

In the example of FIG. 4, the process for client device C11 may be broken up into a plurality of different portions that may be offloaded to a plurality of different SNICs 308. The SNICs 308 among which a given process is delegated may, for example, implement a distributed processing chain that may be executed sequentially.

For example, the process, which may be an NPP pipeline for client device C11 in this case, may be broken up into two sets of components with one set of components being delegated to SNIC 308-1 and the other set of components being delegated to SNIC 308-2. Further, the particular allocation of components to the different SNICs may vary based on the amount of unused computational capacity of the respective SNIC. Accordingly, an SNIC with a greater amount of unused computational capacity may take more components (e.g., more of the offloaded or delegated process for client device C11) than another SNIC with a lesser amount of unused computational resources.

Appreciably, the process may be subdivided into more than two portions and delegated to more than two other SNICs depending on the particular computing node and/or cloud computing system.

In one or more embodiments, if a single stage of a process (e.g., a single stage of an NPP pipeline) is too computationally complex for execution in SNIC 308-3, that particular stage may be broken up into a plurality of groups of the constituent components of the stage and executed in parallel by two or more other SNICs 308. Such parallelization can be performed by any of a variety of mechanisms for machine learning model parallelism known to those skilled in the art. Such mechanisms may include, but are not limited to, pipeline parallelism, tensor parallelism, and/or data parallelism.

In one or more embodiments, a system, e.g., a cloud computing system or environment may have a default configuration in which a CPU offloads the operations described herein to a local SNIC. That SNIC then has the capability of further offloading to respective client devices connected thereto and/or to one or more other SNICs in the (e.g., same) data center. Since the local SNIC is closer to the client, SNIC may communicate with and have a loop with the client device as previously described.

FIGS. 3 and 4 illustrate examples of horizontal distribution of operation. Horizontal distribution of operation refers to the offloading, or delegation, of operations between a plurality of SNICs disposed in a single computing node or between a plurality of SNICs of different computing nodes (e.g., where each SNIC is disposed in a separate computing node). FIGS. 2, 3, and 4 illustrate various types of workload balancing that may be implemented using the vertical and/or horizontal offloading techniques described.

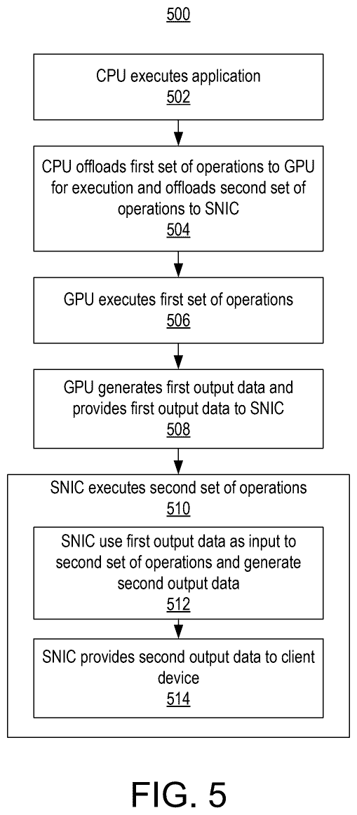

FIG. 5 illustrates a method 500 of offloading operations in accordance with one or more embodiments of the disclosed technology. Method 500 may be performed by a computing environment 100 and, more particularly, by a computing node such as computing node 102 of FIG. 1. As discussed, the computing node may be in communication with one or more client devices.

In block 502, CPU 104 is capable of executing an application. The application may be an online gaming application, a virtual reality application, an augmented reality application, or the like. The application may include or specify a first set of operations and a second set of operations. The first set of operations may include, or be characterized as, colocated operations. An example of colocated operations corresponding to the first set of operations includes graphics rendering pipeline operations. The second set of operations may include, or be characterized as, non-colocated operations. An example of non-colocated operations corresponding to the second set of operations includes NPP operations. NPP operations may include a neural network or at least a portion of a neural network. The neural network may be configured or capable of performing any of the various NPP operations described herein.

In block 504, CPU 104 is capable of offloading the first set of operations to GPU 106 for execution and offloading the second set of operations to SNIC 108-1 for execution. In block 506, GPU 106 is capable of executing the first set of operations. GPU 106 may operate under control of CPU 104 while executing the first set of operations.

In block 508, GPU 106 is capable of generating first output data through execution of the first set of operations and providing the first output data to SNIC 108-1. The first output data may be intermediate data 122. In block 510, SNIC 108-1 executes the second set of operations. In one or more embodiments, as part of block 510, SNIC 108-1 may perform further operations as illustrated in blocks 512 and 514. In block 512, SNIC 108-1 is capable of using the first output data as input to the second set of operations and generate, through execution of the second set of operations using the first output data as input, second output data. The second output data may be augmented data 124. As noted, augmented data 124 may be final data that requires no further processing by client device 110 other than displaying such data. Augmented data 124 may be non-final data that does require further processing by client device 110 prior to display or other usage of that data by client device 110. In any case, in block 514, SNIC 108-1 is capable of providing the second output data to client device 110.

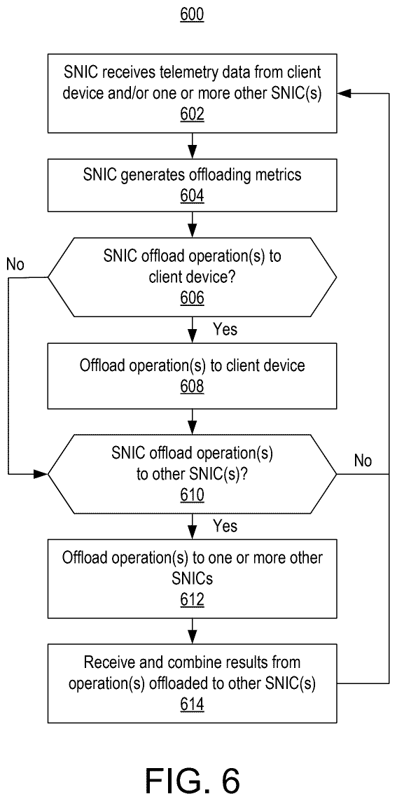

FIG. 6 illustrates a method 600 of offloading operations in accordance with one or more embodiments of the disclosed technology. Method 600 may be performed by SNIC 108-1 and illustrates another example of offloading that may be performed between SNIC 108-1 and client device 110 and/or between SNIC 108-1 and one or more other SNICs 108. In one or more embodiments, method 600 may be performed as part of block 510 of FIG. 5. For example, method 600 may be integrated or interleaved with other operations performed by SNIC 108-1 and performed serially with such other operations, performed as a separate process or thread concurrently with other operations, performed by a separate control processor implemented in SNIC 108-1, or the like.

In block 602, SNIC 108-1 is capable of receiving telemetry data from client device 110 and/or from one or more other SNICs 108. As part of block 602, SNIC 108-1 may also obtain its own telemetry data. In block 604, SNIC 108-1 is capable of generating offloading metrics as described herein. The offloading metrics may indicate information such as operating states of the respective devices including the operating state of SNIC 108-1, workloads and/or capacity of each device, and the like. As discussed, in one or more embodiments, SNIC 108-1 may store or have access to configuration data that specifies one or more offloading criteria that when met, e.g., responsive to detecting a match between the offloading metric(s) and the offloading criteria, cause SNIC 108-1 to offload one or more operations.

In addition, as discussed, the offloading performed by SNIC 108-1 may be performed or initiated by SNIC 108-1 in response to detecting particular conditions such as reaching bandwidth limitations. Such conditions may be reflected as an operating state of the SNIC 108-1 itself and encapsulated as an offloading metric.

In block 606, SNIC 108-1 decides whether to offload one or more operations to client device 110. The decision to offload one or more operations to client device 110 may be performed based on a comparison of the offloading metrics with client offload criteria maintained by SNIC 108-1. In one or more embodiments, the offloading process between SNIC 108-1 and client device 110 may be negotiated between the respective devices based on a current operating state of the SNIC 108-1, a current operating state of client device 110, or both.

In one or more embodiments, SNIC 108-1 is capable of making a decision to offload operation(s) to client device 110 by detecting that the offloading metrics match or meet the client offload criteria, through an agreement reached between SNIC 108-1 and client device 110 through negotiation, or the like. In response to making a decision to offload operation(s) to client device 110, method 600 continues to block 608 where SNIC 108-1 offloads one or more operations to client device 110. In response to a decision that no offload to client device 110 is to occur, method 600 continues to block 610.

In block 610, SNIC 108-1 decides whether to offload one or more operations to one or more other SNICs 108. The decision to offload one or more operations to one or more other SNICs 108 may be performed based on a comparison of the offloading metrics with SNIC offload criteria maintained by SNIC 108-1. In one or more embodiments, the offloading process between SNIC 108-1 and one or more other SNICs 108 may be negotiated between the respective devices based on a current operating state of the SNIC 108-1, a current operating state of the one or more other SNICs 108, or both.

In one or more embodiments, SNIC 108-1 is capable of making a decision to offload operation(s) to the one or more other SNICs 108 by detecting that the offloading metrics match or meet the client offload criteria, through an agreement reached between SNIC 108-1 and the one or more other SNICs 108 through negotiation, or the like. In response to making a decision to offload operation(s) to one or more other SNICs 108, method 600 continues to block 612 where SNIC 108-1 offloads one or more operations to one or more other SNICs 108. In response to a decision that no offload to other SNICs 108 is to occur, method 600 loops back to block 610 to continue processing, thereby achieving dynamic offloading capabilities with respect to client device 110 and/or other SNIC(s) 108.

In block 614, SNIC 108-1 is capable of receiving results from operations offloaded to the one or more other SNIC(s) and combining the results, if necessary. For example, SNIC 108-1 is capable of generating aggregated output data by aggregating output data generated by the SNIC with output data generated by the one or more other SNICs 108. SNIC 108-1 is capable of providing the aggregated output data to client device 110. It should be appreciated that another SNIC 108 other than 108-1 may be responsible for aggregating the output data and/or providing the aggregated output data to client device 110. After block 614, method 600 may loop back to block 602 to continue processing, thereby achieving dynamic offloading capabilities with respect to client device 110 and/or other SNIC(s) 108.

The various operations described herein in connection with FIG. 5 and/or may be performed in real-time or in substantially real-time. For example, operations such as the collection of telemetry data, the computation of offloading metrics, and/or the comparison of such offloading metrics with offloading criteria may be performed in real-time or in substantially real-time such that the various devices described herein may adapt to changing circumstances including operating states of the respective devices and states of the application or state of play of the game(s).

The terminology used herein is for the purpose of describing particular embodiments only and is not intended to be limiting. The following provides explanations of certain terminology used within this disclosure.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “user” may refer to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various embodiments of the disclosed technology have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
executing an application by a Central Processing Unit (CPU) of a computing system, wherein the application includes a first set of operations and a second set of operations;
executing, under control of the CPU, the first set of operations by a Graphics Processing Unit (GPU) of the computing system; and
executing, under control of the CPU, the second set of operations by a Smart Network Interface Controller (SNIC) of the computing system.

2. The computer-implemented method of claim 1, wherein the first set of operations comprise colocated operations and the second set of operations comprise non-colocated operations.

3. The computer-implemented method of claim 1, wherein the first set of operations comprise graphics rendering pipeline operations and the second set of operations comprise neural post-processing operations.

4. The computer-implemented method of claim 3, wherein the neural post-processing operations comprise execution of at least a portion of a neural network.

5. The computer-implemented method of claim 1, comprising:
providing first output data generated through execution of the first set of operations from the GPU to the SNIC, wherein the second set of operations use the first output data as input;
generating second output data by the SNIC; and
providing the second output data from the SNIC to a client device.

6. The computer-implemented method of claim 1, comprising:
offloading, by the SNIC, one or more second operations of the second set of operations to a client device.

7. The computer-implemented method of claim 6, wherein the offloading by the SNIC of the one or more second operations is initiated in response to detecting a match between client offloading criteria and offloading metrics.

8. The computer-implemented method of claim 1, comprising:
offloading, by the SNIC, one or more second operations of the second set of operations to at least one other SNIC.

9. The computer-implemented method of claim 8, wherein the offloading by the SNIC of the one or more second operations is initiated in response to detecting a match between SNIC offloading criteria and offloading metrics.

10. The computer-implemented method of claim 8, comprising:
generating, by the SNIC or the at least one other SNIC, aggregated output data by aggregating output data generated by the SNIC with output data generated by the at least one other SNIC; and
providing the aggregated output data to a client device.

11. A system, comprising:
a Central Processing Unit (CPU) capable of executing an application including a first set of operations and a second set of operations;
a Graphics Processing Unit (GPU) capable of executing, under control of the CPU, the first set of operations; and
a Smart Network Interface Controller (SNIC) capable of executing, under control of the CPU, the second set of operations.

12. The system of claim 11, wherein the first set of operations comprise colocated operations and the second set of operations comprise non-colocated operations.

13. The system of claim 11, wherein the first set of operations comprise graphics rendering pipeline operations and the second set of operations comprise neural post-processing operations.

14. The system of claim 13, wherein the neural post-processing operations comprise execution of at least a portion of a neural network.

15. The system of claim 11, wherein the GPU is capable of generating first output data through execution of the first set of operations and providing the first output data to the SNIC;
wherein the second set of operations use the first output data as input; and
wherein the SNIC is capable of generating second output data and providing the second output data to a client device.

16. The system of claim 11, wherein the SNIC is capable of offloading one or more second operations of the second set of operations to a client device.

17. The system of claim 16, wherein SNIC is capable of initiating offloading of the one or more second operations in response to detecting a match between client offloading criteria and offloading metrics.

18. The system of claim 11, wherein the SNIC is capable of offloading one or more second operations of the second set of operations to at least one other SNIC.

19. The system of claim 18, wherein the SNIC is capable of initiating offloading of the one or more second operations in response to detecting a match between SNIC offloading criteria and offloading metrics.

20. The system of claim 18, wherein the SNIC or the at least one other SNIC is capable of generating aggregated output data by aggregating output data generated by the SNIC with output data generated by the at least one other SNIC and providing the aggregated output data to a client device.
